(19) United States
(12) Patent Application Publication
(10) Pub. No.: US 2023/0223772 A1
(43) Pub. Date: Jul. 13, 2023

(54) ELECTRICAL CHARGING STRUCTURE

(71) Applicant: JOLT CHARGE PTY LTD., Sydney, New South Wales (AU)

(72) Inventor: Douglas MCNAMEE, Sydney, New South Wales (AU)

(21) Appl. No.: 18/001,029

(22) PCT Filed: Jun. 10, 2021
(86) PCT No.: PCT/AU2021/050594

§ 371 Date: Dec. 7, 2022

(30) Foreign Application Priority Data
Jun. 12, 2020 (AU) 2020901948

(51) Int. Cl. H02J 7/00; B60L 53/14; B60L 53/30; B60L 53/68

(52) U.S. Cl. CPC H02J 7/0042; B60L 53/14; B60L 53/305; B60L 53/68

(57) ABSTRACT

An electrical charging structure comprising: a plurality of panels coupled to a frame surrounding an electricity distribution asset; a roof panel fastened to the plurality of panels, thereby substantially enclosing the electricity distribution asset; and an electrical charging device having an electrical charging cable supported upon an external surface of a panel of the plurality of panels, wherein the electrical charging device is electrically connected to an electrical distribution board of the electrical distribution asset within an area substantially enclosed by the electrical charging structure.

### RELATED APPLICATIONS

The present application claims priority from Australian Provisional Patent Application No. 2020901948, filed 12 Jun. 2020, the content of which is herein incorporated by reference in its entirety.

### TECHNICAL FIELD

The present invention relates to an electrical charging structure. In one non-limiting example, the electrical charging structure is configured for charging electric vehicles.

### BACKGROUND

As electric vehicles, such as electric cars, electric bikes and the like, increase in popularity, there is an increased need for the installation of electrical charging stations, particularly in public areas where a user may need to recharge an electric vehicle. The installation of electrical charging stations can be costly. For example, electrical vehicles need to be charged using high voltage charging infrastructure. This infrastructure is most efficient when it is direct current (DC) fast charging. DC fast charging infrastructure is typically costly to install due to the requirements needed to connect this infrastructure to the grid.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

It is an object of the present invention to substantially overcome or at least ameliorate one or more disadvantages of existing arrangements.

In a first aspect, the present invention provides an electrical charging structure comprising: a plurality of panels coupled to a frame surrounding an electricity distribution asset; a roof panel fastened to the plurality of panels, thereby substantially enclosing the electricity distribution asset; and an electrical charging device having an electrical charging cable supported upon an external surface of a panel of the plurality of panels, wherein the electrical charging device is electrically connected to an electrical distribution board of the substation or electrical transformer within an area substantially enclosed by the electrical charging structure.

In certain embodiments, the frame is fastened, via mounting brackets, to a supporting frame of the electricity distribution asset.

In certain embodiments, the plurality of panels includes one or more door panels which are hingedly connected to the frame to enabled access to the electricity distribution asset substantially enclosed within the electrical charging structure.

In certain embodiments, each door panel includes a plurality of ventilation holes.

In certain embodiments, the plurality of panels includes an electronic display panel, wherein content is presented by the electronic display panel in response to user operation of the electrical charging device.

In certain embodiments, the panel supporting the electrical charging cable has an externally facing front wall and side wall, wherein the electrical charging cable is supported upon the front wall of the respective panel, wherein the side wall of the respective panel is located adjacent to the electronic display panel.

In certain embodiments, the sum of a width of the side wall of the panel supporting the electrical charging cable and a width of the electronic display panel is substantially equal to a width of the front wall of the panel supporting the electrical charging cable and a door panel of the one or more door panels.

In certain embodiments, the electrical charging structure further comprises a computing device in electrical communication with the one or more display panels, wherein the computing device controls display of the content by the one or more display panels.

In certain embodiments, the electrical structure includes an electrical equipment compartment located between the roof panel and a roof surface of the electricity distribution asset, wherein the electrical equipment compartment houses an electrical charger assembly of the electrical charging device, wherein the electrical charger assembly is electrically connected to the electrical cable which is supported upon an external surface of the electrical charging structure.

In certain embodiments, the electrical charging structure comprises of or is coupled to a wireless communication device, wherein the computing device is configured to receive, via the wireless communication device, the content from a remote server processing system.

In certain embodiments, the electrical charging station includes a battery, wherein the battery is configured to power the one or more electrical panels with electrical power in order to present the content in response insufficient electrical power being provided by the distribution board of the substation or electrical transformer.

In certain embodiments, in the event the battery is used to power the one or more electronic panels, the computing device is configured to control the one or more electrical display panels to present the content indicative of an electrical fault currently being experienced by a portion of an electricity grid which the electrical transformer or substation forms part thereof.

In certain embodiments, the further comprising a camera device projecting outwardly from the electrical charging structure, wherein footage captured by the camera is received by the computing device and stored in memory.

In certain embodiments, the roof panel includes a plurality of elongate ventilation holes to provide ventilation to the one or more display panels.

In certain embodiments, the roof panel includes a plurality of hoist points to allow the electrical charging structure to be lifted from surrounding the electricity distribution asset.

In certain embodiments, the roof panel includes one or more inclined surfaces to promote run-off of debris and/or water via one or more conduits forming part of the frame.

In certain embodiments, the one or more inclined surfaces include a pair of main inclined surfaces to promote run-off of water and/or debris, each main inclined section extending between a central portion of the roof panel toward a one or more holes in the roof panel in communication with a respective one or more conduits forming part of the frame.

In certain embodiments, the one or more inclined surfaces include a pair of upturned end surfaces, each upturned end surface being adjacent to a respective main inclined surface and having an opposing inclination to the respective adjacent main inclined surface.

In certain embodiments, the electrical charging device includes a cable retraction mechanism to retract the electrical cable after use.

In another aspect, there is provided a method of installing an electrical charging structure about an electricity distribution asset, wherein the method includes: locating a frame around a periphery of the electricity distribution asset; coupling a plurality of panels to the frame, wherein an electrical charging device having an electrical charging cable is supported upon an external surface of a panel of the plurality of panels; fastening a roof panel to the plurality of panels to enclose the electricity distribution asset; and electrically connecting the electrical charging device to an electrical distribution board of the substation or electrical transformer within an area substantially enclosed by the electrical charging structure.

In certain embodiments, locating the frame about the periphery comprises fastening mounting brackets to a supporting frame of the electricity distribution asset, wherein the frame is mounted to the mounting brackets.

Other aspects and embodiments will be appreciated throughout the description of the examples.

### BRIEF DESCRIPTION OF THE FIGURES

Example embodiments should become apparent from the following description, which is given by way of example only, of at least one preferred but non-limiting embodiment, described in connection with the accompanying figures.

FIG. 1 is a side view of an example of an electrical charging structure.

FIG. 2 is a perspective view of the electrical charging structure of FIG. 1.

FIG. 3 is an opposing side view of an example of the electrical charging structure of FIG. 1.

FIG. 4 is an end view of the electrical charging structure of FIG. 1.

FIG. 5 is a perspective view of another example of an electrical charging structure with a door panel open to access an electrical distribution asset.

FIG. 6 is a perspective view of the electrical charging structure of FIG. 1 with the roof removed.

FIG. 7 is perspective view of another example of an electrical charging structure.

FIG. 8 is a perspective view of the electrical charging structure of FIG. 7 with a door panel open.

FIG. 9 is a side view of the electrical charging structure of FIG. 7.

FIG. 10 is an opposing side view of the electrical charging structure of FIG. 7.

FIG. 11 is an end view of the electrical charging structure of FIG. 7 with a panel supporting an electrical charging cable open.

FIG. 12 is a plan view of an example of an electrical charging structure with the roof removed.

FIG. 13 is a system diagram showing connections between electrical components of the electrical charging structure of FIGS. 1 and 7.

FIG. 14 is a perspective view of a further example of an electrical charging station.

FIG. 15 is a first end view of the electrical charging station of FIG. 14.

FIG. 16 is first side view of the electrical charging station of FIG. 14.

FIG. 17 is a second side view, opposing the first side view, of the electrical charging station of FIG. 14.

FIG. 18 is a plan view of the electrical charging station of FIG. 14.

FIG. 19 is a second end view, opposing the first end view, of the electrical charging station of FIG. 14.

FIG. 20 is a perspective view of another example of an electrical charging station.

FIG. 21 is a perspective view of the electrical charging station of FIG. 20, wherein each door and panel is opened.

### DETAILED DESCRIPTION OF THE EMBODIMENTS

The following modes, given by way of example only, are described in order to provide a more precise understanding of the subject matter of a preferred embodiment or embodiments. In the figures, incorporated to illustrate features of an example embodiment, like reference numerals are used to identify like parts throughout the figures.

Referring to the figures there is shown a number of examples of an electrical charging structure 100. The electrical charging structure 100 comprises of a plurality of panels 110, a roof panel 120 and an electrical charging device 130. The plurality of panels 100 are coupled to a frame 160 surrounding an electricity distribution asset 1000 such as an electrical kiosk, transformer or substation. The roof panel 120 is fastened to the plurality of panels 110, thereby substantially enclosing the electricity distribution asset 1000. The electrical charging device 130 has an electrical charging cable 136 supported upon an external surface of a panel of the plurality of panels 110, wherein the electrical charging device 130 is electrically connected to an electrical distribution board 1010 of the electricity distribution asset 1000 within an area 200 substantially enclosed by the electrical charging structure 100.

Advantageously, by installing the electrical charging structure 100 about an existing electricity distribution asset 1000, a high voltage DC power source suitable for recharging of electric vehicles, for example electric cars and bikes, can be utilised without needing new installation of such electrical infrastructure. The electrical charging structure 100 improves the speed and efficiency which electrical chargers can be deployed, whilst increasing safety and ease of use and allowing for utility scale infrastructure to be placed in suitable locations.

The electrical charging device 130 can be electrically connected to the electricity distribution asset by creating a weatherproof conduit in the side of an outer casing of the electricity distribution asset. Electrical cables are threaded through and terminated on the distribution board of the electrical distribution asset 1000 within the casing thereof. In one form, the electrical charging device 130 can be a Delta DC Wallbox 25 kW electric vehicle charger available from NHP or a Veefil-RT 50 kW DC Fast Charger available from Tritium. It will be appreciated that other electric chargers may be utilised. In one form, the electrical charging structure 1000 may include a plurality of electrical charging devices 130, thereby allowing for multiple electrical vehicles to be simultaneously charged.

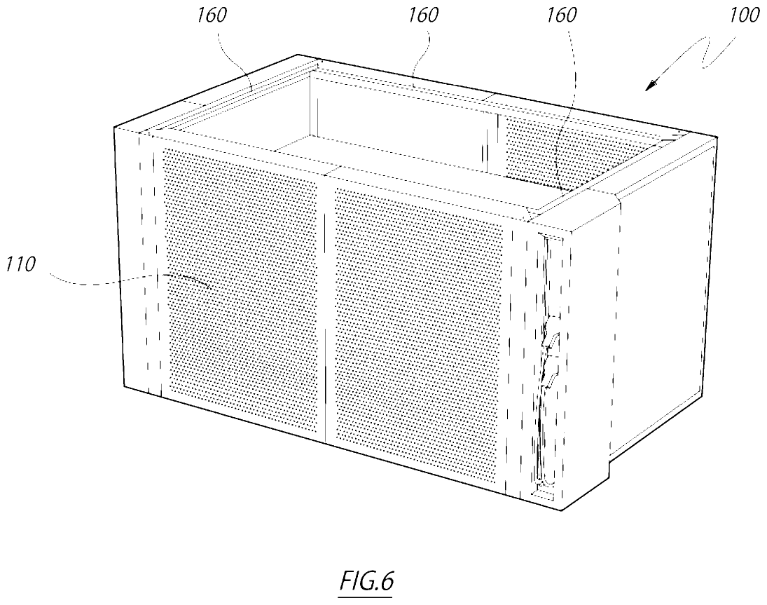

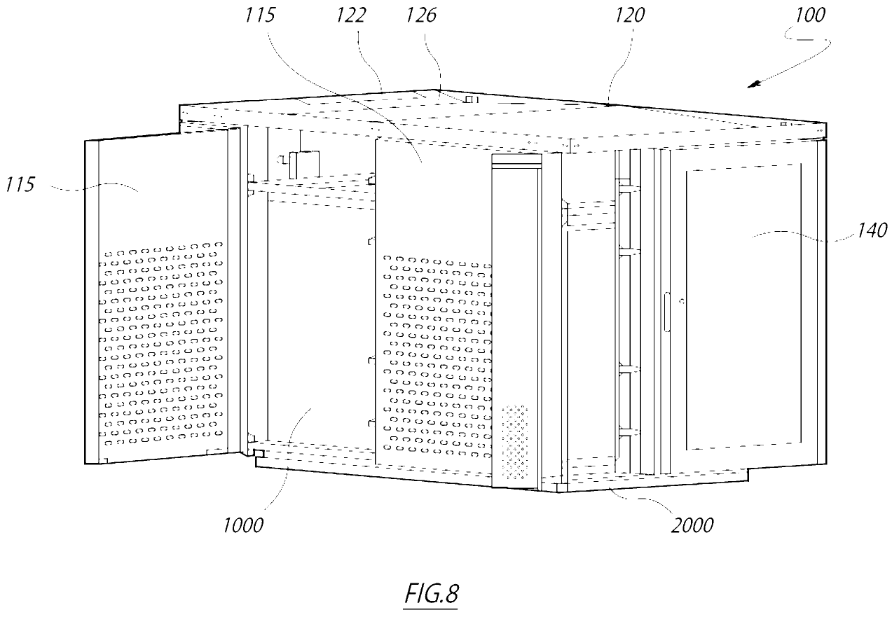

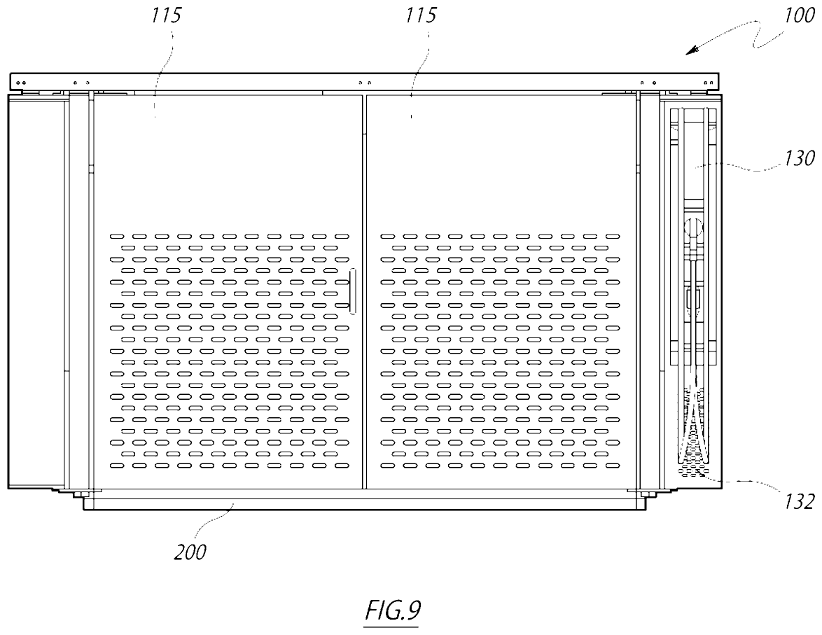

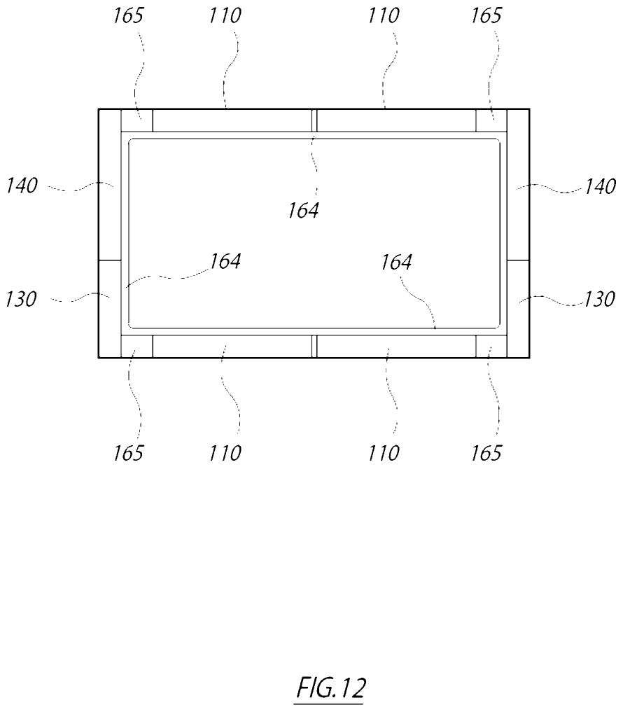

Referring to FIGS. 6 and 9, the frame 160 is fastened, via mounting brackets, to a supporting frame in the form of a base plate 200 supporting the electricity distribution asset 1000. In particular, the mounting brackets are fastened with bolts. Referring specifically to FIG. 12, the frame 160 comprises a plurality of hollow posts 165 forming corner posts of the frame 160. The posts 165 simultaneously provide structural support for the panels 110 which are coupled to the frame 160 whilst additionally acting as downpipes to provide a conduit for clearing debris and/or water which can collect on the roof panel 120. As shown in FIG. 12, the frame 160 further comprises a plurality of transverse frame members 164 which extend between the corner posts 165. The posts 165 are coupled to the mounting brackets which are coupled to the base plate.

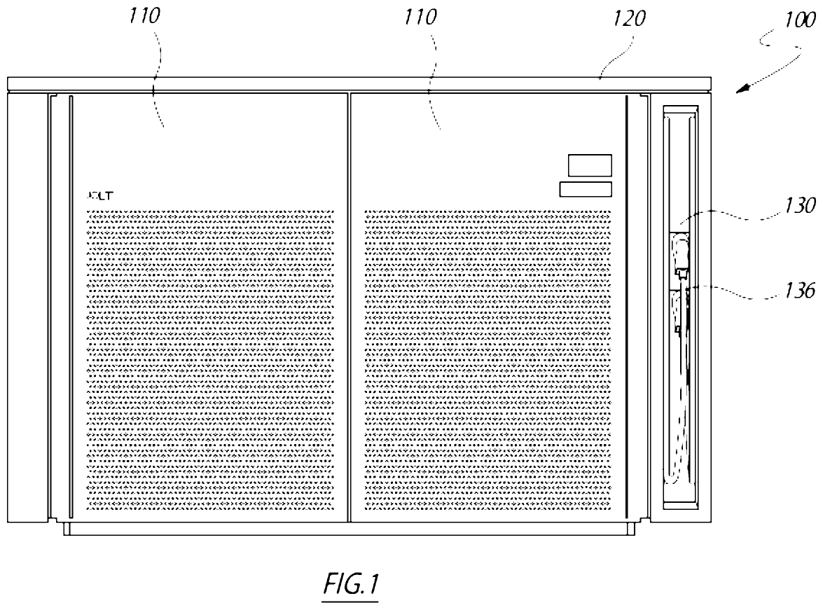

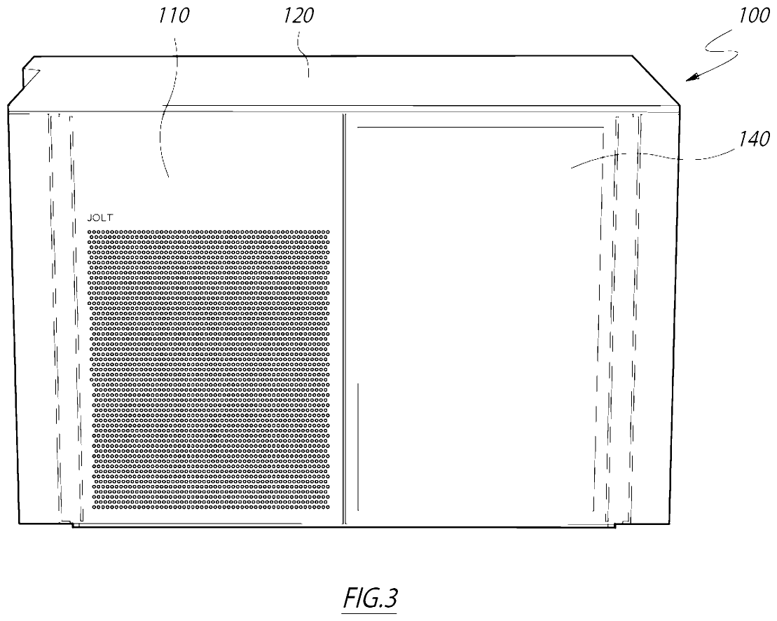

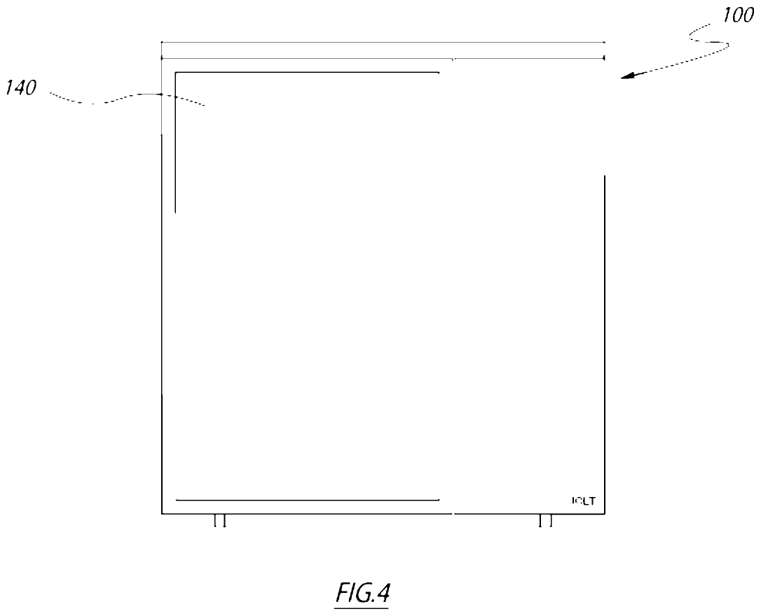

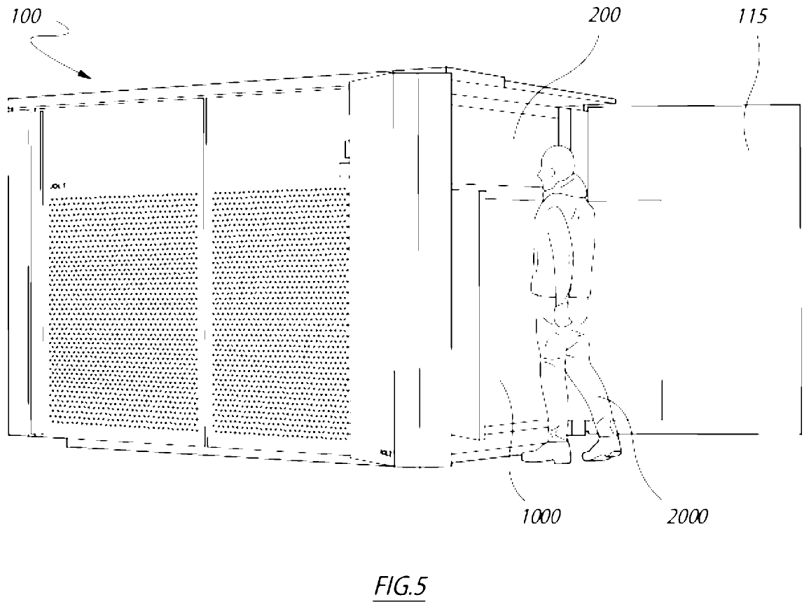

Referring to FIGS. 1 to 12, the plurality of panels 110 are mounted about the periphery of the frame 160 thereby surrounding the case of the electricity distribution asset. The plurality of panels 110 can be coupled to the frame 160 using fastening means such as screws, bolts, nuts, etc.

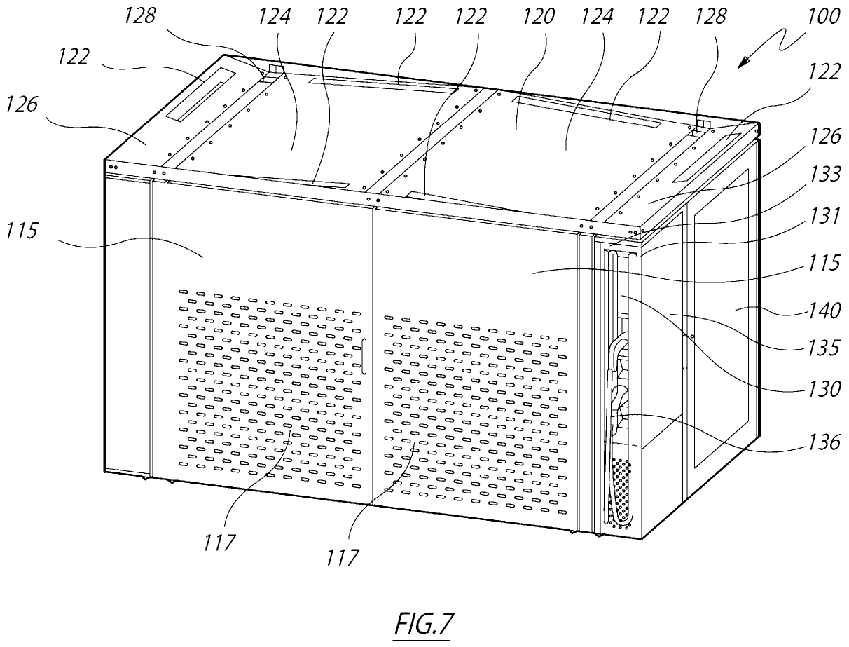

As can be seen in a number of the figures, the plurality of panels 110 includes one or more door panels 115 which are hingedly connected to the frame 160 to enable access for an operator 2000 to the electricity distribution asset 1000 substantially enclosed within the electrical charging structure 100. The door panels 115 can be mounted adjacently to each other along a longitudinal side of the frame 160. However, in other embodiments where the environment may prevent a hinged door 115 being hingedly mounted to the longitudinal side of the frame 160, at least one of the door panels 115 can be mounted to a shorter side of the frame. If multiple door panels 115 are mounted to the frame 160, the door panels can be hingedly mounted to opposing ends of the frame 160, thereby allowing access within the electrical charging structure 100 from opposing ends rather than from one of the longer side walls. Whilst the example shown in FIGS. 7 to 11 illustrates that the electrical charging structure 100 includes a plurality of hinged doors, such as two adjacently mounted doors, it is possible that the electrical charging structure can include only one door. In the instance that two doors are mounted adjacently to each other, the double side swing door hinging allows for the doors of the door panels to open past 90 degrees to provide access to the asset 1000.

As the electrical distribution asset generates heat, at least some of the panels 110 can include a plurality of ventilation holes 117. In one form, the plurality of ventilation holes 117 of each panel can be provided in the form of a perforated mesh or screen structure.

The plurality of panels 110 can also include an electronic display panel 140, wherein content is presented by the electronic display panel 140 in response to user operation of the electrical charging device 130. For example, the content may include instructions for operating the electrical charging device 130. The electronic display panel 140 includes a frame having coupled thereto an electronic screen 148. The frame of the electronic display panel 140 can be mounted to the frame 160 of the electrical charging structure 100. Preferably, the electronic screen 148 substantially extends from a bottom edge of the electronic display panel 140 to the roof panel 120.

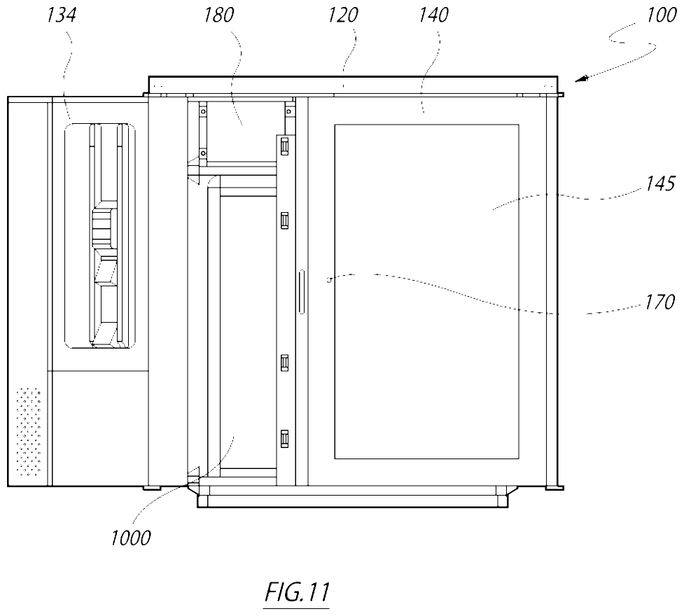

As shown in FIG. 11, the electrical charging structure 100 includes an electrical equipment compartment 180 located between the roof panel 120 and a roof surface of the electricity distribution asset 1000. The electrical equipment compartment 180 houses a computer device 1330 and an electrical charger assembly of the electrical charging device 130. The electrical charger assembly is electrically connected to the electrical cable 132 which is supported upon the external surface of the electrical charging structure 100. In addition, the electrical equipment compartment 180 can house an electrical charging structure distribution board 1310, a secondary (backup) power source 1320, and electrical protection equipment (not shown).

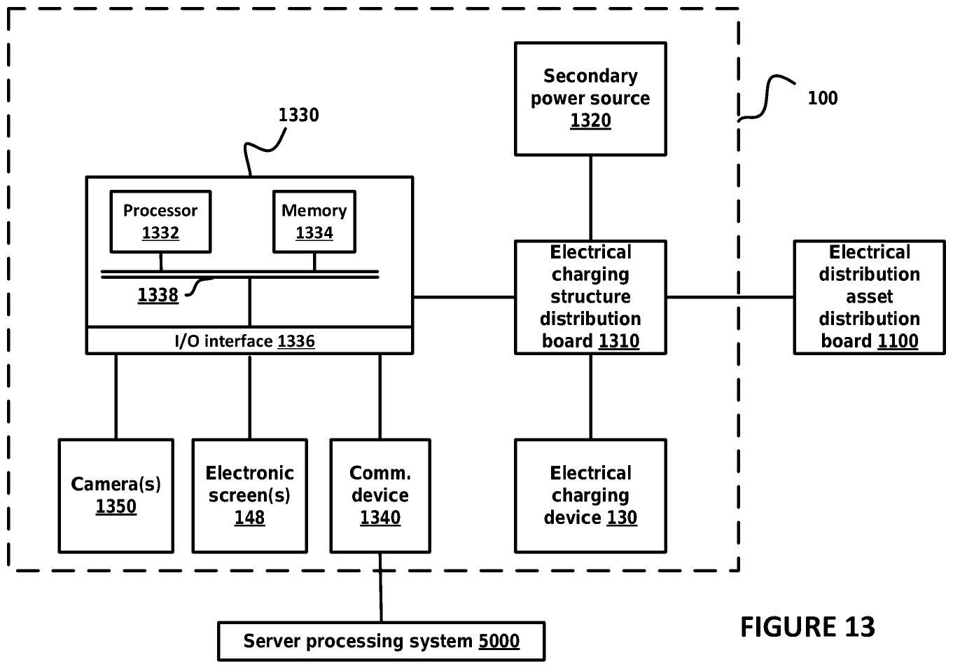

As shown in FIG. 13, the computing device 1330 is in electrical communication with the electronic screen 148 of the electronic display panel 140. The computer device 1330 is configured to control display of the content by the one or more display panels 140. The computing device 1330 can include a processor 1332, a memory 1334, and an input/output (i/o) interface 1336, coupled together via a bus 1338. The computer device 1330 is electrically coupled to the screen 148 of the electronic display panel 140 via the i/o interface 1336. The computer device 1330 includes or has coupled to the i/o interface a communication module 1340 such as a wireless modem. The computing device 1330 has a computer program stored in non-transitory memory 1334 including executable instructions which when executed by the processor configure the computing device to control the presentation of content via the electronic screen 148 of the electronic display panel 140.

In one form, at least some of the content which is presented via the electronic screen 148 is stored locally within memory 1334 of the computer device 1330. For example, at least some of the content is indicative of operating instructions which are presented to a user of the electrical charging structure 1000 when operating the electrical charging device 130. In one form, the electrical charging device 130 is in electrical communication with the computing device 1330, wherein an electrical signal is transferred from the electrical charging device 130 to the computing device 1330 in response to the electrical charging cable being withdrawn from a retractable cable mechanism supported upon the external surface of one of the plurality of panels 110, wherein in response to the computing device 1330 receiving the signal, the computing device 1330 retrieves content stored in local memory and controls the presentation of the content via the electronic screen 148 of the electronic display panel 140. In an additional or alternate form, the computing device 1330 may retrieve the content from local memory 1334 in response to user input via one or more input devices. In one form, the electronic screen 140 may be a touch sensitive screen, wherein the user may interact with the touch screen 148 to provide input, wherein in response to detecting a touch event, the processor 1332 of the computer device 1330 retrieves content from the local memory which is presented to the user via the electronic screen 148.

In another form, the content may be indicative of a safety message. For example, the safety messaging content may indicate when the one or more electrical charging devices 130 are available or unavailable for use. In an additional or alternate form, the content may also be indicative of pricing information for electricity.

In one form, at least some of the content which is presented via the electronic screen 148 is received, via the wireless communication device 1340, from a remote server processing system 5000. In one form, content may be pushed or pulled from the remote server processing system 5000. In one form, the content may be advertising content which is presented by the computer device 1330 in the event that electrical charging device 130 is not operational by a user. In response to the computer device 1330 detecting user operation of the electrical charging device 130, the computer device 1330 can switch presentation of content via the electronic screen 148 from advertising content to operating instruction content related to safe operation of the electrical charging device 130.

The electrical charging structure 100 can further comprise the secondary electrical power source 1320 which is separate to the electrical power provided by the electrical distribution asset 1000 via the respective distribution board 1100. In particular, the secondary electrical power source 1320 may be provided in the form of a rechargeable battery such as an uninterrupted power supply (UPS). The battery 1320 can be electrically coupled to the electrical distribution board 1310 via a charging assembly to charge the battery. The battery 1320 is configured to provide electrical power to the one or more electronic screens 148 of the respective one or more electrical panels 140 in response insufficient electrical power being provided by the distribution board of the asset 1000. For example, an electrical network which the asset 1000 is part thereof may be experiencing a power outage such that the one or more electronic screens 148 cannot receive electrical power from the distribution board 1100 of the asset 1000 during the power outage. In response to the power outage, the battery 1320 is used to provide electrical power to the one or more electronic screens 148 of the one or more electronic panels 140 such that content can be presented during the outage. During the outage, the computer device 1330 is also in electrical communication with the battery 1320. In one form, content presented via the one or more electronic screens 148 during an outage may be received from the remote server processing system 5000 indicative of the power outage. Alternatively, upon detecting a power outage, the computer device 1300 can receive the power outage content from the server processing system 5000, wherein the power outage content is then presented via the one or more electronic screens during the power outage. The power outage content may be indicative of the area which is experiencing the power outage and the estimated restoration time. Additionally or alternatively, generic power outage content can be presented which merely indicates that the respective asset 1000 is not receiving electrical power from the network. The generic power outage content can be presented until custom power outage content is received from the server processing system 5000.

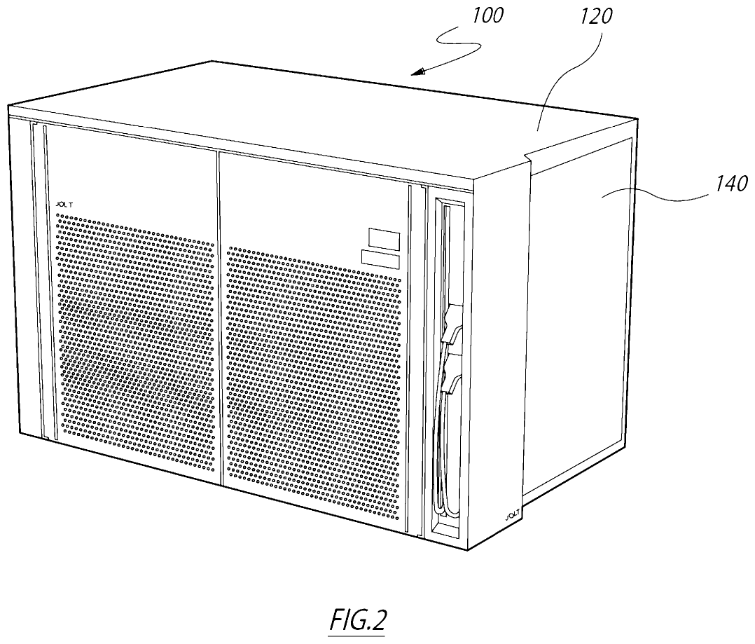

Referring to FIGS. 2 and 7, the panel 131 supporting the electrical charging cable has an externally facing front wall 133 and side wall 135. As such, the panel 131 has wall portions 133, 135 that extends orthogonally relative to each other. The electrical charging cable 136 is supported upon the front wall 133 of the respective panel 131 via a cable retraction mechanism (not shown). In particular, the electrical cable 136 can be withdrawn from the cable retraction mechanism in order to couple the electrical charging connector to an electrical vehicle, and upon disconnecting the electrical charging connector from the electric vehicle, the electrical cable 136 is automatically withdrawn back into a housing of the cable retraction mechanism. As shown in FIG. 11, the panel 131 supporting the electrical charging cable 136 is hingedly connected to the frame 160 to enable access and maintenance.

As shown in FIG. 7, the side wall 135 of the panel 131 supporting the electrical cable 136 (herein referred to as the ‘electrical cable panel 131’) is located adjacent to the electronic display panel 140 when mounted to the frame 140. Furthermore, the front wall 133 of the electronic display panel 131 is located adjacent the door panel 115. The front and side walls 133, 135 of the electrical cable panel 131, the door panels 115 and the electronic display panel 140 are sized to provide modular flexibility with mounting the panels to the frame in particular orientations and configurations during installation. In particular, the sum of a width of the side wall 135 of the electrical cable panel 131 and a width of the electronic display panel 140 is substantially equal to a width of the front wall 133 of the electrical cable panel and a door panel 115 of the one or more door panels. For example, as shown in FIG. 7, the door panels may be located adjacently to each other along a longitudinal side of the electrical charging structure. However, in some environments, there may be an obstruction which prevents the hinged doors both being located along the longitudinal side. As such, at least one of the door panels 115 can be hingedly mounted to one of the ends of the electrical charging structure 1000 and the electronic display panel 140 can be interchangeably mounted to the frame 160 along the longitudinal side of the electrical charging structure 1000. It will be appreciated that the electrical cable panel 131 may need to be swapped with an adjacent corner panel (which may also be an electrical cable panel) such that the front wall 133 of the opposing corner panel is mounted to the frame adjacent the door panel 115 and the side wall 135 is mounted adjacent the electronic display panel 140. Such mounting configurations may also be taken into account when installing the electrical charging structure 1000 in relation to the orientation of the electronic display panel 140. For example, an installer of the electrical charging structure 1000 may determine, based on the environment (e.g. pathways, adjacent roads, etc) that it would be more preferable that the one or more electrical display panels 140 are mounted to the ends of frame 160 rather than along the longitudinal side of the frame 160. As the panels 115, 131, 140 are sized to allow reconfigurable mounting to the frame, it is possible to take such environmental factors into account when mounting the panels 115, 131, 140 during installation of the electrical charging structure 1000.

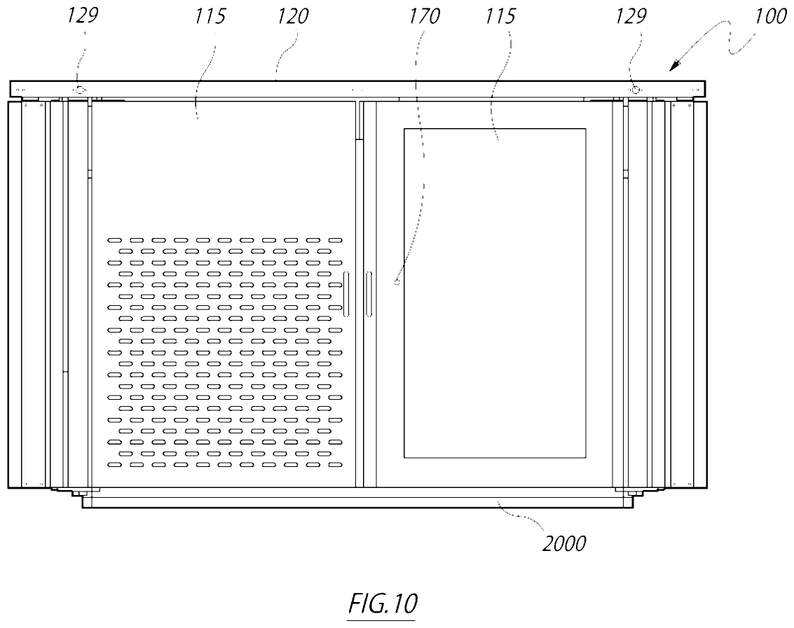

As shown in FIGS. 10 and 11, the electrical charging structure can further comprise a camera device 170 projecting outwardly from the electrical charging structure 1000, wherein footage captured by the camera 170 is received by the computing device 1330 and stored in memory 1334. Activity that occurs about the structure 1000 can be monitored using the captured footage, including security, user activity and audience activity. In one form, the computing device 1330 may also record in memory unique identities associated with wireless devices detected within a wireless communication proximity of the wireless communication device 1340. For example, the identity of Bluetooth enabled devices which are detected can be recorded in memory 1334 to provide an indication of viewership of the content being presented.

Referring to FIGS. 7 and 8, the roof panel 120 can include a plurality of elongate ventilation holes 122 to provide ventilation to the one or more display panels 140. As will be seen from the figures, the roof panel 122 can include multiple spare ventilation holes 122 which may not align with the one or more electronic display panels 140. However, the multiple spare ventilation holes 122 are provided in the roof panel 122 to provide flexibility with mounting the panels 110 in different configurations depending upon the installation environment.

As shown in FIG. 10, the roof panel 120 includes one or more hoist points 129 to allow the electrical charging structure 100 to be lifted from surrounding the electricity distribution asset 1000. For example, in the event that there is an emergency, such as electrical fire in the asset 1000, the electrical charging structure 100 can be uncoupled from the mounting brackets, such that a hoisting mechanism such as a crane or the like, can lift the electrical charging structure 100 above the electricity distribution asset 1000 to allow for repair or replacement.

As seen in FIGS. 1 to 11, the roof panel can include one or more inclined surfaces to promote run-off of debris and/or water via one or more conduits 165 forming part of the frame 160. As shown in FIG. 1, the roof panel 120 includes a single inclined surface. However, as shown in an alternate example in FIG. 7, the roof panel 120 includes multiple inclined surfaces. In particular, the roof panel 120 include a pair of main inclined surfaces 124 to promote run-off of water and/or debris. Each main inclined section 1201 extends between a central portion of the roof panel 20 toward one or more holes 128 in the roof panel in communication with the posts 165 of the frame 160. As shown in FIGS. 7 and 8, the roof panels include a pair of upturned end surfaces 126. Each upturned end surface 126 is located adjacent to a respective main inclined surface 124 and has an opposing inclination to the respective adjacent main inclined surface 124.

The electrical charging structure 100 can be installed using the following method. Initially, a frame 160 is located about the periphery of the electricity distribution asset. As explained above, the frame 160 can be mounted to mounting brackets which are fastened to the base plate supporting the electricity distribution asset 1000. Next, the method includes coupling a plurality of panels 110 to the frame 160, wherein an electrical charging device 130 having an electrical charging cable 136 is supported upon an external surface of a panel 131 of the plurality of panels 110. Due to the modular sizing of the panels 110, the panels 100 can be mounted in various configurations to the frame 160 depending upon environmental factors which may impede opening of doors panels 115 and viewing of the electronic display panel 130. Next, the method includes fastening the roof panel 120 to the plurality of panels 110 to enclose the electricity distribution asset 1000. The roof panel 120 can be fastened to the panels 110 via a fastening means. The method then includes electrically connecting the electrical charging device 130 to an electrical distribution board 1100 of asset 1000 within an area 200 substantially enclosed by the electrical charging structure 1000.

The panels 110 and roof panel 115 are preferably made from a metal material.

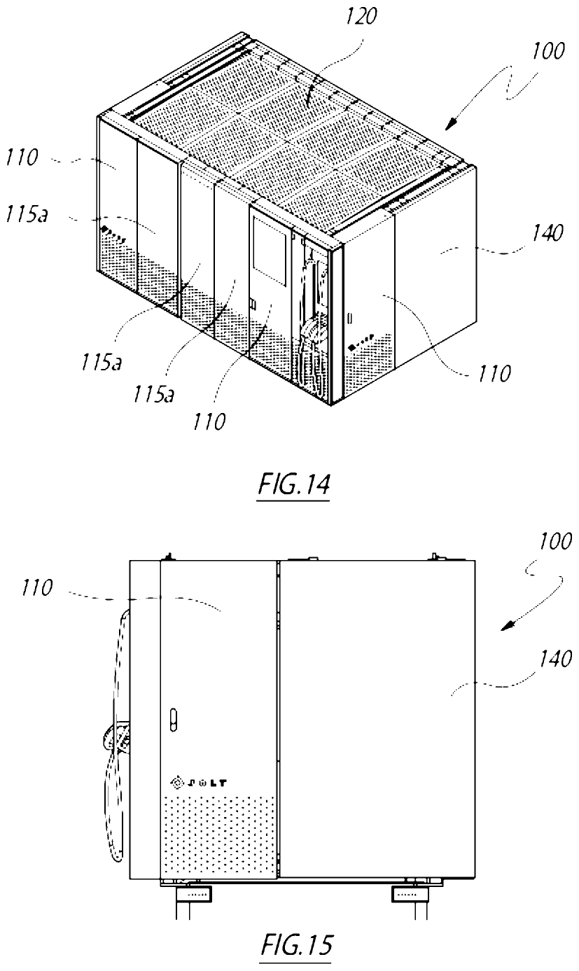

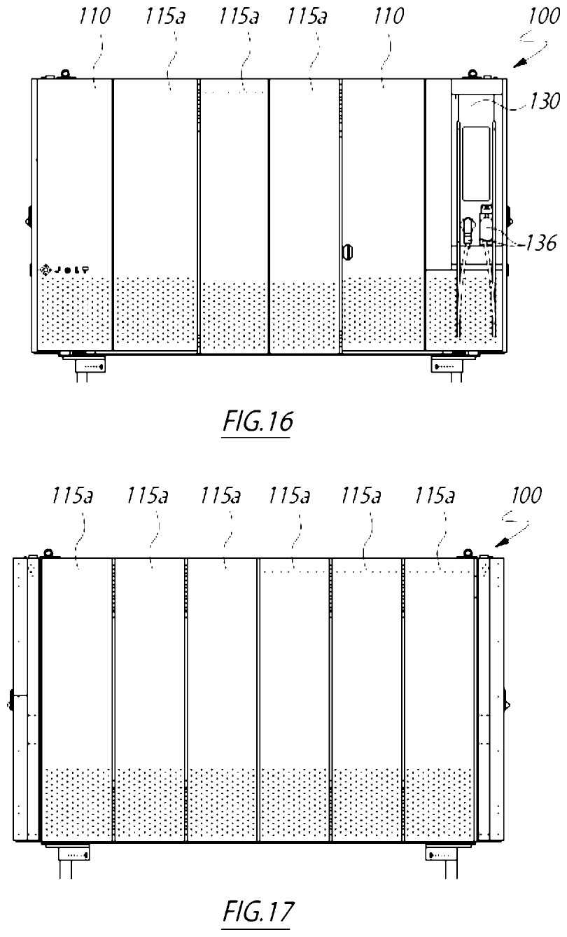

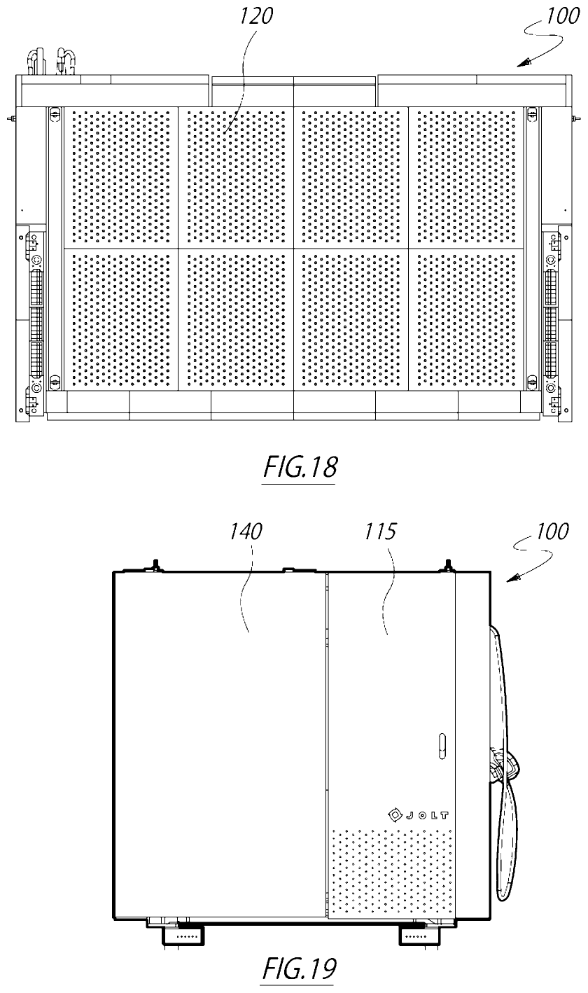

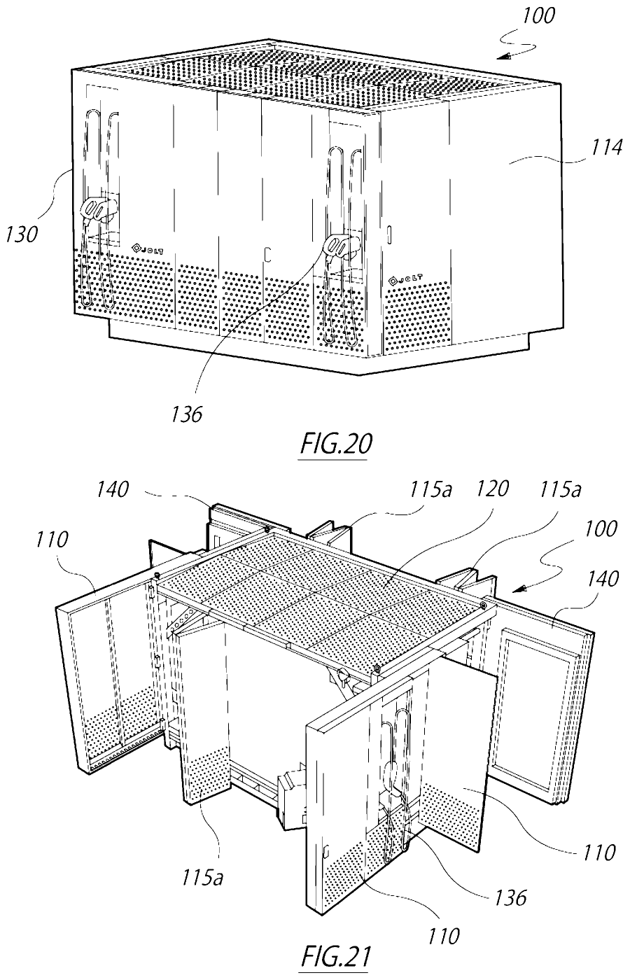

Referring to FIGS. 14 to 19 there is shown a further implementation of the electrical charging station. FIGS. 20 and 21 further illustrate another implementation of the electrical charging station. For the purposes of clarity, features which differ to earlier described embodiments will be herein described.

As shown in FIG. 14, the roof panel 120 can include a perforated structure 100 for ventilation of heat from the electrical charging structure.

As shown in FIGS. 14 and 21, at least some of the panels are connected together in a bi-fold or multi-fold arrangement 115a. As the bi-fold/multi-fold configuration 115a of the respective panels have a smaller footprint in the open position as shown in FIG. 21 compared to earlier described hinged panel configuration, the electrical charging structure 100 to be installed in areas where there may be obstructions.

Many modifications will be apparent to those skilled in the art without departing from the scope of the present invention.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

1-21. (canceled)

22. An electrical charging structure comprising:
a plurality of panels coupled to a frame surrounding an electricity distribution asset, wherein the plurality of panels includes an electronic display panel configured to present content;
a roof panel fastened to the plurality of panels, thereby substantially enclosing the electricity distribution asset; and
an electrical charging device having an electrical charging cable supported upon an external surface of a panel of the plurality of panels, wherein the electrical charging device is electrically connected to an electrical distribution board of the electrical distribution asset within an area substantially enclosed by the electrical charging structure; and
a computing device in electrical communication with the electronic display panel, wherein the computing device controls the electronic display panel; and
a secondary power source, wherein the secondary power source is configured to power the electronic display panel and the computing device with electrical power in response to insufficient electrical power being provided by the electrical distribution board of the electrical distribution asset.

23. The electrical charging structure of claim 22, wherein the frame is fastened, via mounting brackets, to a supporting frame for the electricity distribution asset.

24. The electrical charging structure of claim 23, wherein the plurality of panels includes one or more door panels which are hingedly connected to the frame to enabled access to the electricity distribution asset substantially enclosed within the electrical charging structure.

25. The electrical charging structure of claim 22, wherein at least some of the panels include a plurality of ventilation holes.

26. The electrical charging structure of claim 22, wherein the panel supporting the electrical charging cable has an externally facing front wall and side wall, wherein the electrical charging cable is supported upon the front wall of the respective panel, wherein the side wall of the respective panel is located adjacent to the electronic display panel.

27. The electrical charging structure of claim 22, wherein the sum of a width of the side wall of the panel supporting the electrical charging cable and a width of the electronic display panel is substantially equal to a width of the front wall of the panel supporting the electrical charging cable and a width of a door panel of the one or more door panels.

28. The electrical charging structure of claim 22, wherein the electrical structure includes an electrical equipment compartment located between the roof panel and a roof surface of the electricity distribution asset, wherein the electrical equipment compartment houses an electrical charger assembly of the electrical charging device, wherein the electrical charger assembly is electrically connected to the electrical cable which is supported upon an external surface of the electrical charging structure.

29. The electrical charging structure of claim 22, wherein the electrical charging structure comprises or is coupled to a wireless communication device, wherein the computing device is configured to receive, via the wireless communication device, the content from a remote server processing system.

30. The electrical charging structure of claim 22, wherein in the event the secondary power source is used to power the one or more electronic panels, the computing device is configured to control the one or more electrical display panels to present the content indicative of a power outage currently being experienced by a portion of an electricity network which the electrical distribution asset forms part thereof.

31. The electrical charging structure of claim 22, further comprising a camera device projecting outwardly from the electrical charging structure, wherein footage captured by the camera is received by the computing device and stored in memory.

32. The electrical charging structure of claim 22, wherein the roof panel includes a plurality of elongate ventilation holes to provide ventilation to the one or more display panels.

33. The electrical charging structure of claim 22, wherein the roof panel includes one or more hoist points to allow the electrical charging structure to be lifted from surrounding the electricity distribution asset.

34. The electrical charging structure according to claim 22, wherein the roof panel includes one or more inclined surfaces to promote run-off of debris and/or water via one or more conduits forming part of the frame.

35. The electrical charging structure of claim 34, wherein the one or more inclined surfaces include a pair of main inclined surfaces to promote run-off of water and/or debris, each main inclined section extending between a central portion of the roof panel toward one or more holes in the roof panel.

36. The electrical charging structure of claim 35, wherein the one or more inclined surfaces include a pair of upturned end surfaces, each upturned end surface being adjacent to a respective main inclined surface and having an opposing inclination to the respective adjacent main inclined surface.

37. The electrical charging structure of claim 22, wherein the electrical charging device includes a cable retraction mechanism to retract the electrical cable after use.

38. A method of installing an electrical charging structure of any one of the preceding claims about the electricity distribution asset of an electrical substation or transformer, wherein the method includes:
locating the frame around the periphery of the electricity distribution asset;
coupling the plurality of panels to the frame, wherein the electrical charging device having an electrical charging cable is supported upon the external surface of a panel of the plurality of panels;
fastening the roof panel to the plurality of panels to enclose the electricity distribution asset;
electrically connecting the electrical charging device to the electrical distribution board of the electrical distribution asset within the area substantially enclosed by the electrical charging structure; and
electrically connecting the electronic display panel, the computing device, the secondary power source, and the electrical distribution board of the electrical distribution asset to each other within an area substantially enclosed by the electrical charging structure.

39. The method according to claim 38, wherein locating the frame about the periphery comprises fastening mounting brackets to the supporting frame of the electricity distribution asset, wherein the frame is mounted to the mounting brackets.
